(19) United States
(12) Patent Application Publication
(10) Pub. No.: US 2025/0354871 A1
(43) Pub. Date: Nov. 20, 2025

(54) THREE-DIMENSIONAL THERMAL IMAGING SYSTEM AND METHOD

(71) Applicant: The Governors of the University of Alberta, Edmonton (CA)

(72) Inventors: Ahmed Qureshi, Edmonton (CA); Mohammad Keshmiri, Edmonton (CA); Shirin Dehgahi, Edmonton (CA)

(73) Assignee: The Governors of the University of Alberta, Edmonton, AB (CA)

(21) Appl. No.: 19/208,953

(22) Filed: May 15, 2025

Related U.S. Application Data
(60) Provisional application No. 63/648,864, filed on May 17, 2024.

(51) Int. Cl. G01J 5/48; G01J 5/00; G01J 5/04; G01N 25/72; G06T 7/00

(52) U.S. Cl. CPC G01J 5/485; G01J 5/047; G01N 25/72; G06T 7/0004; G01J 2005/0077; G06T 2207/10048

(57) ABSTRACT

A three-dimensional thermal (3D) thermal imaging system including a 3D scanner configured to capture 3D point cloud data of a 3D object; a thermal imaging device configured to capture a thermal image of the 3D device; and a processing core configured to align the 3D point cloud data and the thermal image and to assign thermal image data from pixels of the thermal image to each point of the three-dimensional point cloud data. A method for 3D thermal imaging including capturing three-dimensional point cloud data of a 3D object using a 3D scanner, capturing a thermal image of the 3D device using a thermal imaging device, aligning the 3D point cloud data and the thermal image using a processing core, and assigning thermal image data from pixels of the thermal image to each point of the 3D point cloud data using the processing core to create a 3D thermal image.

### RELATED APPLICATIONS

This application claims priority benefit of U.S. Provisional Application Ser. No. 63/648,864 filed, 17 May 2024, the contents of which are hereby incorporated by reference.

### FIELD OF THE INVENTION

The present invention relates generally to a system and method for acquiring three-dimensional (3D) thermal imaging, and in particular to a system and method for use thereof for simultaneously acquiring 3D point cloud data of an object and thermal images of the object and merging the acquired 3D point cloud data and the thermal images together.

### BACKGROUND OF THE INVENTION

The ability to present 3D thermal images is of great interest for many applications, such as rover navigation, industrial plant monitoring, rescue robots, oil and sand, and additive manufacturing. For example, the geometrical properties of additively manufactured parts can be influenced by temperature variation during printing. Thermal characteristics and surface attributes are the two most influential parameters on mechanical properties. Optimizing these factors can lead to desired mechanical properties according to the application of printed parts. Similarly, such 3D thermal images could aid engineers with the critical task of assessing the overall integrity of oil and gas pipelines by considering thermal anomalies and defects that can be detected from friction or corrosion.

Nowadays, industries are exploring new techniques to gain real-time control over production parameters in which digital twin can lead them to achieve desired parts with specific properties. Currently, multiple scanning devices are utilized in the fabrication process to achieve geometrical information; however, this data is not related to thermal readings.

Thus, there exists a need for a system and method for acquiring 3D thermal imaging in order to have immediate 3D thermal images that can aid in a variety of settings including defect detection.

### SUMMARY OF THE INVENTION

The present invention provides a three-dimensional (3D) thermal imaging system. The inventive 3D thermal imaging system includes a 3D scanner, a thermal imaging device, and a processing core. The 3D scanner is configured to capture 3D point cloud data of a 3D object. The thermal imaging device is configured to capture a thermal image of the 3D device. The processing core is configured to align the 3D point cloud data and the thermal image and to assign thermal image data from pixels of the thermal image to each point of the three-dimensional point cloud data.

Additionally, the present invention provides a method for three-dimensional (3D) thermal imaging. The method includes capturing three-dimensional point cloud data of a 3D object using a 3D scanner, capturing a thermal image of the 3D device using a thermal imaging device, aligning the 3D point cloud data and the thermal image using a processing core, and assigning thermal image data from pixels of the thermal image to each point of the 3D point cloud data using the processing core to create a 3D thermal image.

### BRIEF DESCRIPTION OF THE DRAWINGS

The present invention is further detailed with respect to the following figures that depict various aspects of the present invention.

FIG. 1 shows a flowchart of a for simultaneously acquiring 3D point cloud data of an object and thermal images of the object and fusing the acquired 3D point cloud data and the thermal images together in order to provide immediate 3D thermal images according to embodiments of the present invention;

FIG. 2 shows a flowchart of the data pipeline according to embodiments of the present invention;

FIG. 3 shows how the 3D point cloud and the thermal image are aligned, according to embodiments of the present invention;

FIGS. 4A-4C, show embodiments of the inventive system in the process of generating the 3D point cloud based on the depth image or directly using the point cloud;

FIGS. 5A and 5B show embodiments of a fixture for holding the 3D scanner and the thermal imaging device according to embodiments of the present invention;

FIG. 6 shows a flowchart of a process of encoding the thermal image and a depth map to generate the 3D thermal image, according to embodiments of the present invention;

FIGS. 7A and 7B show flowcharts for model training and model execution, respectively;

FIG. 8A represents a thermal image that is acquired through an Xi-400 thermal camera;

FIG. 8B shows the 3D thermal model generated using the inventive system and method of the image of FIG. 8A;

FIG. 8C shows a thermal image that is captured with a Pi 1M thermal camera during the directed energy deposition additive manufacturing process at 650° C.; and

FIG. 8D shows the 3D thermal model generated using the inventive system and method of the image of FIG. 8C.

### DESCRIPTION OF THE INVENTION

The present invention has utility as a system and method for simultaneously acquiring three-dimensional (3D) point cloud data of an object and thermal images of the object and merging the acquired 3D point cloud data and the thermal images together in order to provide immediate 3D thermal images that can aid in a variety of settings including defect detection for manufacturing and/or integrity inspections. By correlating part geometry with thermal behavior, heat concentration locations can be identified, which helps the process of defect detection and allows one to generate an accurate digital shadow of a part. 3D thermal images acquired according to the present invention are useful in additive manufacturing, which requires high-fidelity data, as well as in aiding engineers in assessing the overall integrity of oil and gas pipelines by considering thermal anomalies and defects that can be detected from friction or corrosion.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, a system for simultaneously acquiring 3D point cloud data of an object and thermal images of the object and fusing the acquired 3D point cloud data and the thermal images together in order to provide immediate 3D thermal images includes a 3D scanner that is configured to capture 3D point cloud data of a 3D object, a thermal imaging device that is configured to capture a thermal image of the 3D device, and a processing core that is configured to align the 3D point cloud data and the thermal image and to assign thermal image data from pixels of the thermal image to each point of the 3D point cloud data. According to embodiments, the 3D scanner and the thermal imaging device are configured to scan for the 3D point cloud data and capture the thermal image simultaneously. According to embodiments, the processed data can be stored or used as input for in-situ applications like monitoring and anomaly detection algorithms.

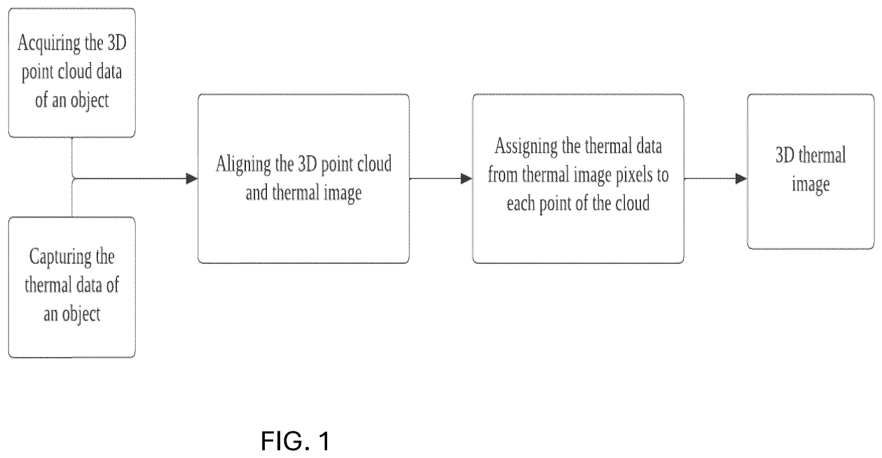

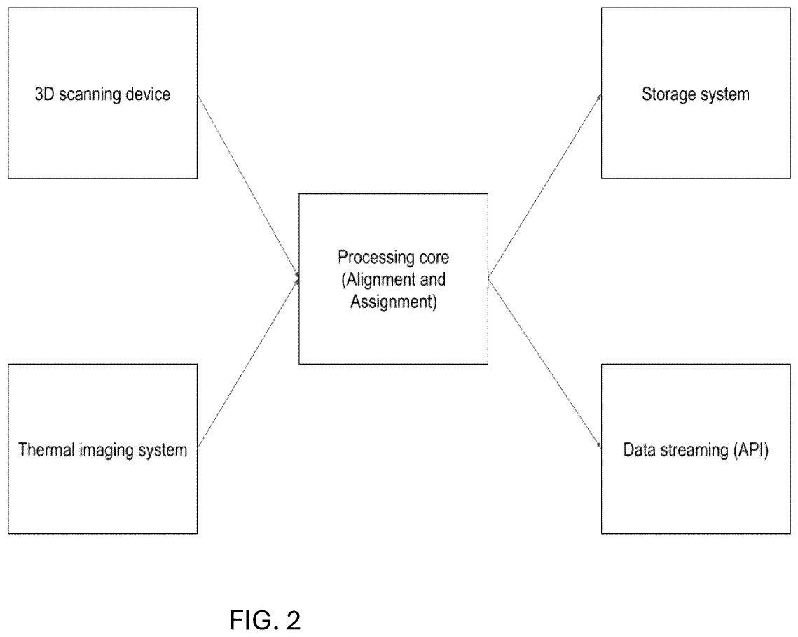

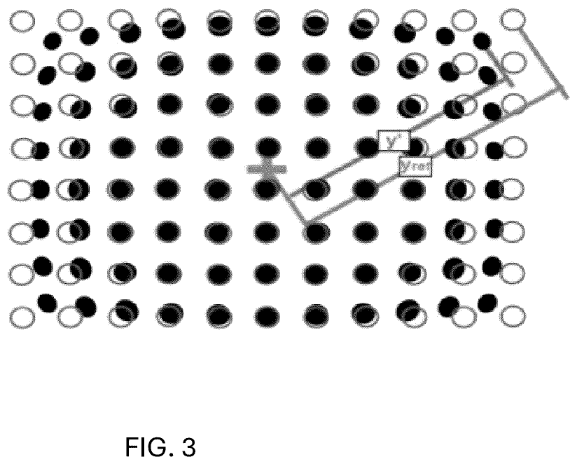

FIG. 1 shows a flowchart of a for simultaneously acquiring 3D point cloud data of an object and thermal images of the object and fusing the acquired 3D point cloud data and the thermal images together in order to provide immediate 3D thermal images according to embodiments of the present invention. The method includes acquiring 3D point cloud data of an object and simultaneously capturing a thermal image of the object, aligning the 3D point cloud and the thermal image, assigning the thermal data from the thermal image pixels to each point of the 3D point cloud, and finally generating a 3D thermal image. In other words, the thermal history of each point of the 3D point cloud is assigned to the corresponding coordination. The processed data can be stored or used as input for in-situ applications like monitoring and anomaly detection algorithms. FIG. 2 shows a flowchart of the data pipeline of the method. FIG. 3 shows how the 3D point cloud and the thermal image are aligned, according to embodiments of the present invention.

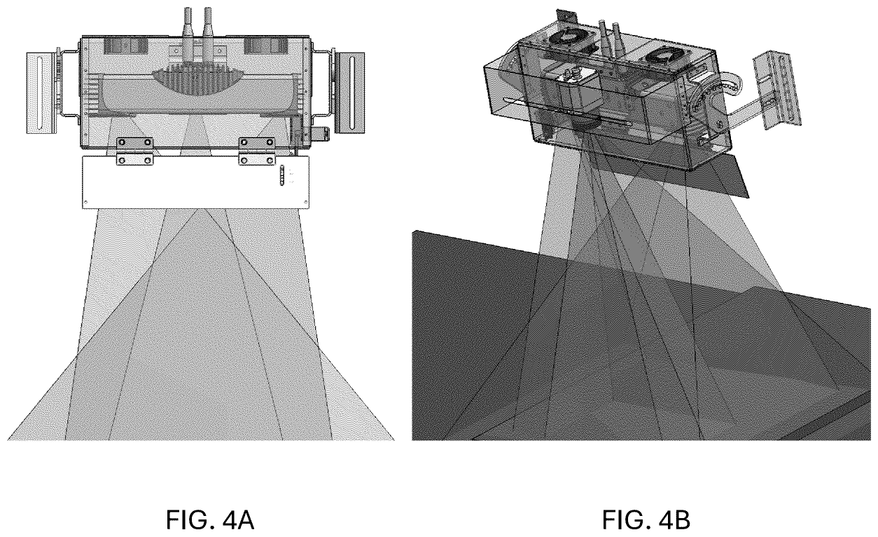

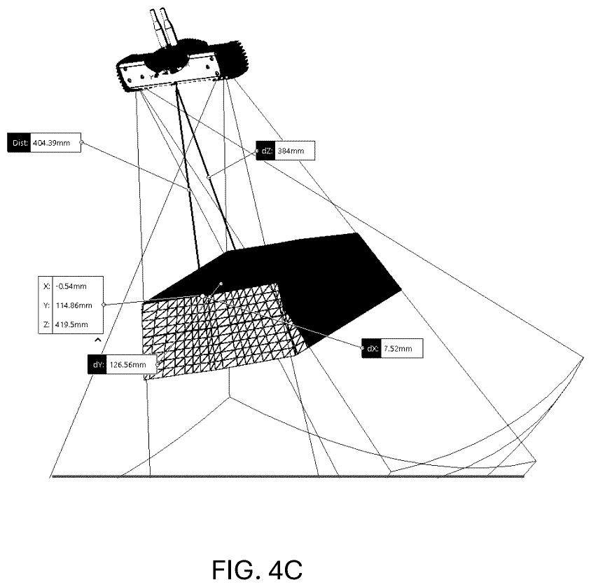

According to embodiments, such as shown in FIGS. 4A-4C, the system can generate the 3D point cloud based on the depth image or directly using the point cloud. The focal length, working distance, and field of view of the 3D scanner and the thermal imaging device can adapt to the region of interest (ROI). According to embodiments, the alignment of these two types of images is done in two steps. The first step is based on the physical position of the 3D scanning device and the thermal imaging device. In this step, the field of view of the inventive 3D thermal system can be calculated according to the distortion and intrinsic parameters of the 3D scanner and thermal imaging device. In the final step, based on the calculated parameters for the thermal imaging device and 3D scanner, the center point of the point clouds and images are aligned in the same space. Utilizing a developed algorithm, each set of cameras can be calibrated.

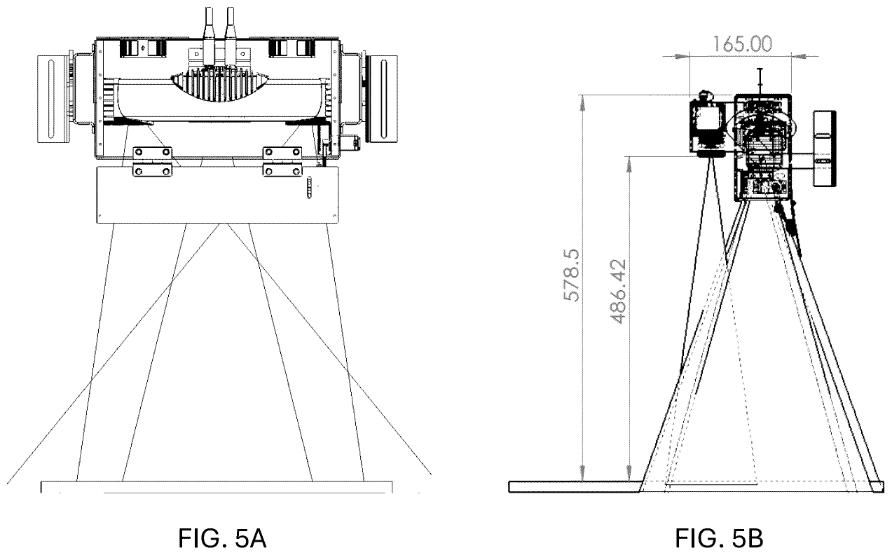

According to embodiments, the inventive system includes a fixture configured to hold the 3D scanner and the thermal imaging device. By using that fixture and inputting the focal length and parameters of the 3D scanner and thermal imaging device, the algorithm of the system can calculate the final field of view for the 3D thermal imaging system. By leveraging the fixture, the system will fuse the ROI thermal data and not process the rest of the area, which leads to lower processing time, enabling immediate 3D thermal imaging for real time use. FIGS. 5A and 5B show embodiments of the fixture. The field of view dimensions will vary depending on the camera's focal length and the working distance.

As the resolution of 3D scanner and thermal imaging device is different, the processing core is responsible for thermal data and point-cloud assignment. Not only does the algorithm register the pixels to points, but it also upsamples the number of pixels to provide a high-density point cloud.

According to embodiments, the processing core is powered by two different algorithms. Firstly, based on the specifications of the 3D scanner and thermal imaging device and working distance, the size and number of pixels of thermal images and a 3D point cloud of the ROI are determined. Then, the processing core calculates the relationship between the number of pixels and the point cloud. This relationship is utilized to fuse the thermal data on the points of the point cloud. On the other hand, the processing core relies on two different deep learning architectures: Graph Neural Networks (GNN), Neural Networks (NN), and foundation models/transformer neural networks.

Multiple algorithms based on the GNN are utilized in the processing core, like GNN, Graph Auto Encoder (GAE), Variational Graph Auto Encoder (VGAE), and Gated Graph Neural Network (GGNN). In all these methods, graph-structured data (point cloud) is the input, and these algorithms help generate the ensembled data of the point cloud. The number of ensembled data is downscaled to be the same as the number of thermal image pixels. Then, the temperature data is attached to the representative points and then upscaled to the original number of points. In this method, the coordination of each point of the point cloud remains untouched, and the processing core tries to add the thermal history of each point to it.

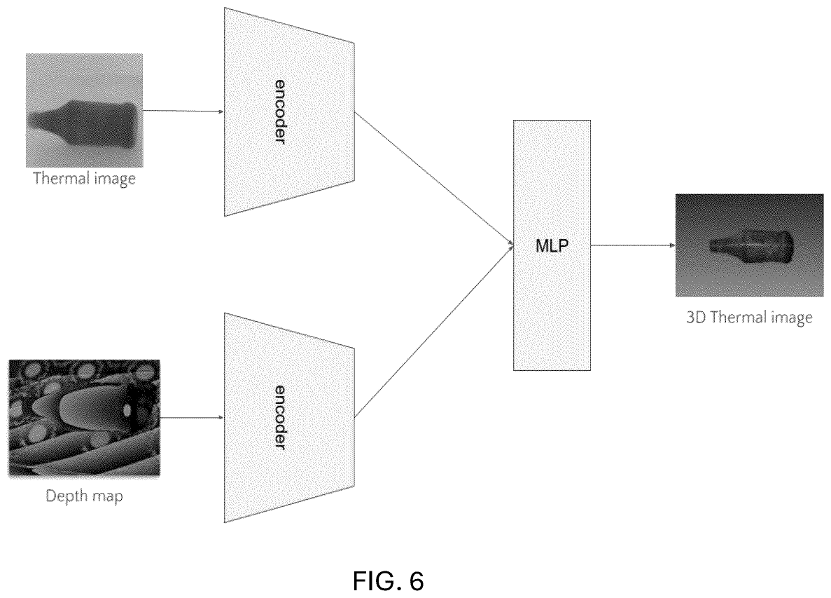

As opposed to the GNN-based methods, two different neural networks are trained as encoders and decoders. One network is trained to extract features from the thermal images. The second network is trained to get the 3D point of data, downsampling that data, and then mapping the temperature of each point based on the derived features from the first network. Then, after the fusing process, the point cloud is regenerated. FIG. 6 shows a flowchart of this process.

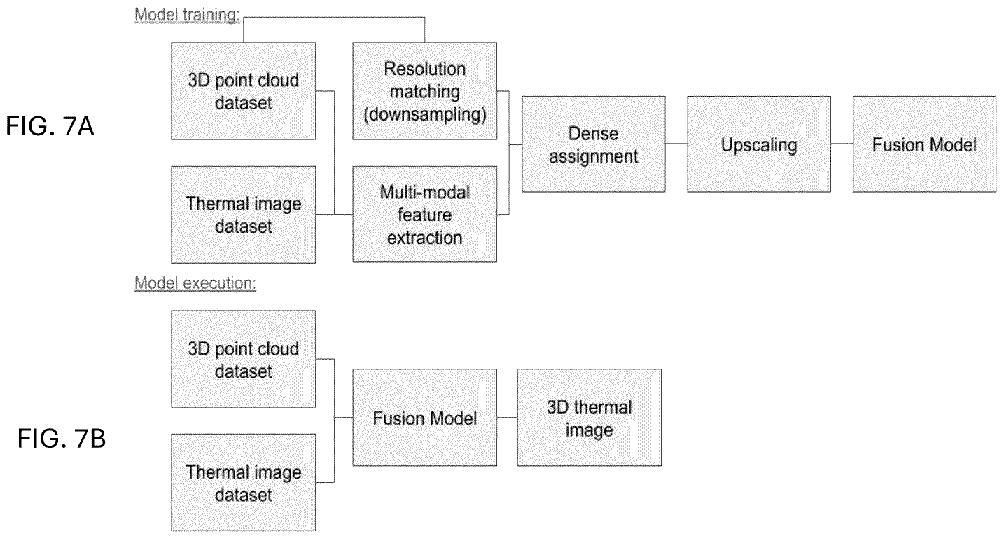

FIGS. 7A and 7B show flowcharts for model training and model execution, respectively. By generating the thermal images based on the inventive method and system, controlling the thermal history in three dimensions will be possible. This data can be utilized for different applications, such as field monitoring and applications in additive manufacturing, which allows industries to delve into 3D thermal history by providing a digital shadow of fabricated parts.

### Example 1

As proof of the inventive system and method, an experiment is conducted using a 3D laser scanner with an accuracy of 20 microns (Photoneo-Model S) and a thermal imaging device (Optris Pi1M and Xi-400).

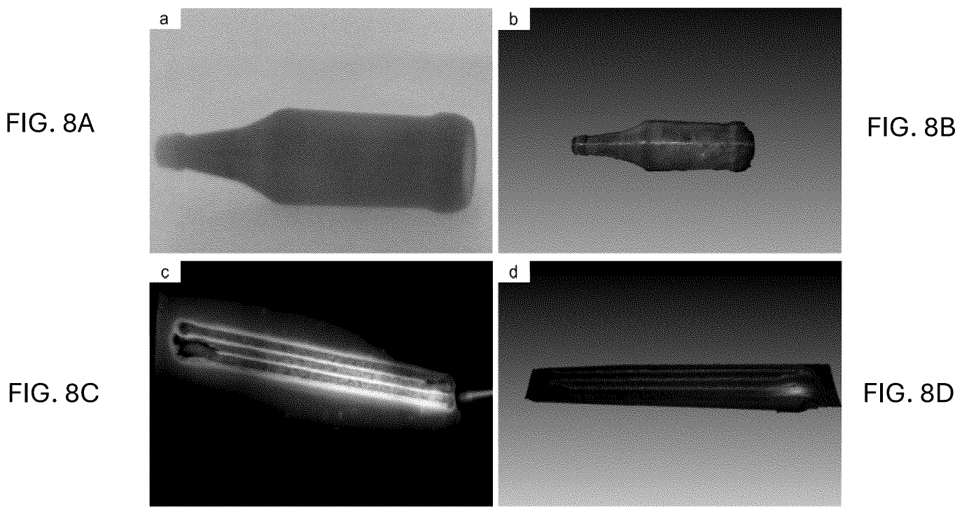

FIG. 8A represents a thermal image that is acquired through an Xi-400 thermal camera. The shape object's temperature is 38° C. The point cloud is captured with the laser 3D scanner, and then, using the algorithm, the 3D thermal model is generated, which is presented in FIG. 8B.

### Example 2

For the higher temperatures case study, FIG. 8C is captured with a Pi 1M thermal camera during the directed energy deposition additive manufacturing process at 650° C. The processed image is presented in FIG. 8D. This 3D thermal image can provide unique multispectral information about the geometrical defects along with the thermal history of each object point that can be used for quality assurance of the manufactured parts.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

While at least one exemplary embodiment has been presented in the foregoing description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing description and incorporated references will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A three-dimensional (3D) thermal imaging system comprising:
a 3D scanner configured to capture 3D point cloud data of a 3D object;
a thermal imaging device configured to capture a thermal image of the 3D device; and
a processing core configured to align the 3D point cloud data and the thermal image and to assign thermal image data from pixels of the thermal image to each point of the three-dimensional point cloud data.

2. The three-dimensional thermal imaging system of claim 1 further comprising a fixture configured to hold the 3D scanner and the thermal imaging device.

3. The three-dimensional thermal imaging system of claim 1 wherein the 3D scanner and the thermal imaging device are configured to scan for the 3D point cloud data and capture the thermal image simultaneously.

4. The three-dimensional thermal imaging system of claim 1 wherein the 3D scanner is a 3D laser scanner.

5. The three-dimensional thermal imaging system of claim 4 wherein the 3D laser scanner has an accuracy of 20 microns.

6. The three-dimensional thermal imaging system of claim 1 wherein the thermal imaging device is a Xi-400 thermal camera.

7. A method for three-dimensional (3D) thermal imaging, the method comprising:
capturing three-dimensional point cloud data of a 3D object using a 3D scanner;
capturing a thermal image of the 3D device using a thermal imaging device;
aligning the 3D point cloud data and the thermal image using a processing core; and
assigning thermal image data from pixels of the thermal image to each point of the 3D point cloud data using the processing core to create a 3D thermal image.

8. The method of claim 7 wherein the 3D point cloud data and the thermal image are captured simultaneously.

9. The method of claim 7 wherein the 3D object is a product of an additive manufacturing process.

10. The method of claim 7 wherein the 3D object is an oil and gas pipeline.

11. The method of claim 7 wherein the 3D thermal image aids in defect detection in additive manufacturing processes.

12. The method of claim 7 wherein the 3D thermal image aids in defect detection in integrity assessments of oil and gas pipelines.

13. The method of claim 7 further comprising storing or using the 3D thermal image as input for in-situ monitoring and anomaly detection algorithms.

14. The method of claim 7 further comprising positioning the 3D scanner and the thermal imaging device relative to the 3D object.

15. The method of claim 7 wherein aligning the 3D point cloud data and the thermal image includes calculating a field of view of the 3D scanner and the thermal imaging device according to a distortion and intrinsic parameters of the 3D scanner and the thermal imaging device.

16. The method of claim 15 wherein aligning the 3D point cloud data and the thermal image additionally includes aligning a center point of the 3D point cloud data and the thermal image based on the calculated field of view of the 3D scanner and the thermal imaging device.

17. The method of claim 7 wherein the processing core is powered by at least one algorithm.

18. The method of claim 7 wherein the processing core relies on Graph Neural Networks (GNN), Neural Networks (NN), and foundation models/transformer neural networks.
